(19) United States
(12) Patent Application Publication
(10) Pub. No.: US 2004/0105485 A1
(43) Pub. Date: Jun. 3, 2004

(54) TEMPERATURE COMPENSATION FOR ACOUSTO-OPTC DEVICES

(75) Inventors: Kenneth J Bures, Marblehead, MA (US); Dogan Gunes, North Andover, MA (US)

Correspondence Address: RAUSCHENBACH PATENT LAW GROUP, LLC, P.O. BOX 387, BEDFORD, MA, 01730, US

(73) Assignee: UNAXIS USA, INC., St. Petersburg, FL (US)

(21) Appl. No.: 10/604,503

(22) Filed: Jul. 25, 2003

Related U.S. Application Data
(60) Provisional application No. 60/319,432, filed on Jul. 29, 2002.

(51) Int. Cl. G01K 1/00

(52) U.S. Cl. 374/142; 374/141

(57) ABSTRACT

Methods and apparatus for compensating for temperature variations in acousto-optic devices are described. An acousto-optic tunable device according to the invention features an acousto-optic substrate having an acoustic wave transducer positioned on the acousto-optic substrate. A temperature sensor is positioned in thermal communication with the acousto-optic substrate. The temperature sensor generates an electrical signal that is related to a temperature of the acousto-optic substrate. A processor generates a control signal in response to the electrical signal generated by the temperature sensor. An oscillator receives the control signal and a frequency of the oscillator is changed in response to the control signal in order to maintain phase-matching criteria of the acousto-optic tunable device as the temperature of the acousto-optic substrate changes.

### CROSS REFERENCE TO RELATED APPLICATIONS

This patent application claims priority to U.S. provisional patent application Serial No. 60/319,432, filed on Jul. 29, 2002, the entire disclosure of which is incorporated herein by reference.

### BACKGROUND OF INVENTION

The present invention relates to temperature compensation in optical devices. In particular, the present invention relates to temperature compensation in acousto-optic devices, such as acousto-optic filters, modulators, and beam deflectors. The invention is described in the context of an acousto-optic tunable filter based on polarization mode conversion, but is applicable to all acousto-optic devices that depend on maintaining specific phase-matching criteria during temperature variations.

Acousto-optic tunable filters (AOTFs) are electrically-tunable optical filters. Wavelength tuning is accomplished by varying a surface acoustic wave frequency applied to the AOTFs. AOTFs are useful for optical filtering and add-drop multiplexing in wavelength division multiplexing (WDM) optical transport systems. WDM is an optical transport technology that propagates many wavelengths in the same optical fiber, thus effectively increasing the aggregate bandwidth per fiber to the sum of the bit rates of each wavelength. Dense Wavelength Division Multiplexing (DWDM) is a technology that implements WDM technology with a large number of wavelengths. DWDM is typically used to describe WDM technology that propagates more than 40 wavelengths in a single optical fiber.

As the number of wavelengths increases, the channel width and channel spacing decreases. To achieve the required channel width and channel spacing in DWDM communication systems, high quality, high performance optical filters are required. In order to function properly, these optical filters generally must exhibit low loss and narrow band transmission characteristics over the wavelength spectrum of 1.3 μm to 1.55 μm. These filters generally must also have good mechanical properties and must be stable in typical operating environments.

AOTFs are particularly advantageous for use in WDM optical transport systems because they can achieve narrow passbands and broad tuning ranges. In fact, an AOTF can have a tuning range that is substantially the entire wavelength range of an optical fiber communication system, which can typically be approximately from 1.3 μm to 1.6 μm. Also, AOTFs have the unique capability of simultaneous multi-channel filtering. By simultaneous multi-channel filtering we mean that an AOTF can select several wavelength channels simultaneously by applying multiple acoustic wave signals. In addition, AOTFs can be configured as add-drop multiplexers. Add-drop multiplexers are used in WDM optical transport systems for adding and dropping one or more channels while preserving the integrity of the other channels.

AOTFs include a narrowband polarization converter that is positioned between an input and an output polarizing element. The polarization converter changes one polarization mode to an orthogonal polarization mode. Light having a wavelength range within the passband of the filter propagates through the input polarizing element and then is converted to an orthogonal state of polarization. The converted light then propagates through the output polarization element.

The degree of polarization transformation depends on the magnitude of the polarization conversion, which is a function of the applied acoustic power density. However, the polarization converter is inoperative outside of the passband of the filter. Light having a wavelength range outside of the passband does not get converted by the polarization converter and, therefore, is blocked from propagating through the AOTF.

Known AOTFs have several practical limitations that have prevented them from being used in commercial WDM optical transport systems. For example, typical materials used for AOTFs have relatively large sensitivity to temperature variations. These temperature variations can have undesirable consequences. For example, such temperature variations can result in one or more unwanted wavelengths being propagated within the passband of the filter. Propagating unwanted wavelengths is undesirable because the AOTF must remain “tuned” to a single optical wavelength over the operating temperature range.

Furthermore, it is relatively difficult and expensive to control the temperature of an AOTF to within a desired temperature range. If the desired temperature range is not achieved, the temperature offset from nominal can cause a shift in the wavelength where the filter is phase matched. In addition, a temperature gradient along the AOTF can result in asymmetric sidelobes and incomplete mode conversion, which can cause an unacceptable level of crosstalk and which can broaden the filter bandwidth.

One or more heaters or thermoelectric coolers can be used to control the temperature of the devices. However, such heaters and coolers typically consume a relatively large amount of power, are physically large and significantly add to the cost of the device. Additionally, to obtain the desired temperature accuracy, a temperature control system may be required. A suitably accurate temperature control system may need to sense the temperature at several locations along the length of the AOTF. Separate control loops may be required for each temperature sensor. Such a temperature control system can significantly add to the cost of deploying the AOTF.

Known methods to solve this problem include the use of a thermoelectric cooler (TEC) in close proximity to the AOTF substrate in order to keep the AOTF at a constant temperature regardless of the ambient temperature. However, thermoelectric coolers can be undesirable because they are generally expensive, bulky, require considerable electric power, and require a relatively large heat sink for the “hot” side.

### BRIEF DESCRIPTION OF DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a known integrated acousto-optic tunable filter.

FIG. 2 illustrates a known temperature controlled AOTF that includes an integrated AOTF and a thermoelectric cooler for maintaining the substrate of the integrated AOTF at a relatively constant temperature.

FIG. 3 is a flow diagram of an embodiment of a method of maintaining phase-matching criteria of an acousto-optic tunable filter (AOTF) during temperature variations according to the present invention.

FIG. 4 illustrates an embodiment of a temperature compensated acousto-optic tunable filter device according to the present invention.

FIG. 5 illustrates another embodiment of a temperature compensated acousto-optic tunable filter device according to the present invention.

### DETAILED DESCRIPTION

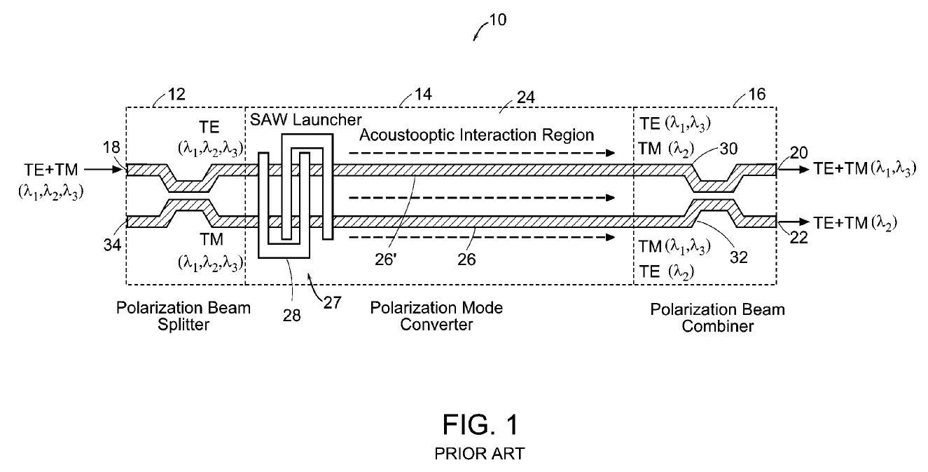

FIG. 1 illustrates a known integrated acousto-optic tunable filter (AOTF) 10. The AOTF 10 includes an input polarization beamsplitter 12, a polarization mode-converter 14, and a polarization beam combiner 16. The polarization beamsplitter 12 receives an input light beam at a first input 18 and separates the input light beam into two orthogonal polarization states, which are typically the TE and TM modes. The two modes propagate through the polarization mode-converter 14 and are combined by the polarization beam combiner 16. The modes are either coupled straight through or crossed over to a first 20 and second output port 22 of the polarization beam combiner 16.

The polarization mode-converter 14 changes one polarization mode to another polarization mode by propagating light through an acousto-optic interaction region 24. The polarization mode-converter 14 includes a pair of parallel optical waveguides 26, 26′ that are formed in the surface of a substrate (not shown). Strain is induced in the acousto-optic interaction region by the piezoelectric effect. The substrate is a piezoelectric and a birefringent material that includes an off-diagonal term in the substrate material's strain-optic tensor. The elasto-optic tensor P relates the mechanical strain in the material to the optical index of refraction of the material. For example, lithium niobate has an off-axis elasto-optic tensor term of p₄₁.

The polarization mode-converter 14 also includes a surface acoustic wave (SAW) transducer 27, which in one configuration, is a set of inter-digitated conducting fingers 28 that are formed over or proximate to the pair of optical waveguides 26, 26′. The optical waveguides 26, 26′ carry the separated TE and TM modes that are formed by the polarization beamsplitter 12. A sinusoidal oscillator (not shown) that generates an acoustic waveform having a frequency fₐ is electrically connected to the conducting fingers 28 of the SAW transducer 27. The sinusoidal oscillator drives the conducting fingers 28 and generates a surface acoustic wave (SAW) that propagates approximately collinearly along the pair of optical waveguides 26, 26′. In one configuration, the SAW itself is guided through the use of an acoustic waveguide structure.

The SAW causes an anisotropic perturbation of the indices of refraction in the pair of optical waveguides 26, 26′. This perturbation causes a mode conversion. By mode conversion, we mean a conversion of one mode to another mode (e.g., TE becomes TM, and TM becomes TE). The mode conversion occurs gradually as the optical signals propagate through the pair of optical waveguides 26, 26′. Mode conversion only occurs when phase matching criteria is satisfied. This is when the optical wavelength #₀ and the acoustic drive frequency fₐ are related by Equation (1) as follows:

$${f}_{a} = \frac{Δ n {V}_{S}}{{λ}_{0}}$$

where #n=n_{TM}−n_{TE} is the birefringence of the optical waveguide material, and Vₛ is the speed of sound in the substrate material. Eventually, complete mode conversion of the phase-matching optical signals occurs. This is when substantially the entire TE mode is converted to the TM mode in one waveguide 26′ and substantially the entire TM mode is converted to the TE mode in the other waveguide 26 of the pair of optical waveguides 26, 26′.

Mode conversion continues to occur as long as the acoustically generated perturbation is present. That is, after complete mode conversion, the just-formed TM mode begins to convert back to TE mode and the just-formed TE mode begins to convert back to the TM mode. The TE mode and the TM mode that are propagating through the pair of optical waveguides 26, 26′, thus could convert cyclically back and forth from pure TE to pure TM and then back again.

The AOTF 10 halts the mode conversion by terminating the acoustic signal with acoustic absorbers (not shown) that are positioned on the pair of optical waveguides 26, 26′ at specific locations. This ensures that the light beam having the phase-matching optical wavelength #₀ will undergo substantially complete mode conversion. If the optical wavelength #₀ of the light beam is not phase-matched to the acoustic frequency fₐ, then substantially no mode conversion occurs, and the light beam simply propagates down the waveguide 26, 26′ with no change in polarization.

The polarization beam combiner 16 is physically identical to the polarization beamsplitter 12. However, the polarization beam combiner 16 is configured to combine rather than split the light beams. The polarization beam combiner 16 has a first 30 and a second input port 32 that receives the TM mode and the TE mode.

Integrated AOTFs combine the polarization beamsplitter 12, polarization mode-converter 14, and the polarization beam combiner 16 on a planar substrate that is birefringent, photoelastic, and piezoelectric, such as lithium niobate. Discrete AOTFs use separate polarization beamsplitters, polarization beam combiners, and acousto-optic interaction regions. The principles of operation of integrated and discrete AOTFs are similar.

In operation, a single-mode optical beam comprising, for example, three channels centered at optical wavelengths #₁, #₂, and #₃ enters the polarization beamsplitter 12 through the first input 18. The polarization beamsplitter 12 separates the optical beam into TE and TM modes. The TE and TM modes propagate down separate waveguides 26, 26′ in the polarization mode-converter 14. Portions of the TE and TM modes are mode-converted by the polarization mode-converter 14. The TE and TM modes are then combined in the polarization beam combiner 16.

The mode-converter oscillator frequency is chosen to phase-match to one of the three optical channels. For example, the oscillator frequency can be chosen to phase-match to #₂. In this configuration, the portions of the TE and TM modes centered at #₂ are mode-converted to TM and TE, respectively, while portions centered at other wavelengths propagate down the waveguides without any polarization mode conversion. The TE mode couples straight through the polarization beam combiner 16 and the TM mode crosses over in the polarization beam combiner 16. Polarization splitters and combiners can also be designed to couple the TM mode straight through and to cross-couple the TE mode. In this configuration, the overall operation of the filter is the same.

The second output port 22 of the polarization beam combiner 16 produces the combined TE+TM components centered at the phase-matching wavelength #₂ whereas the first output port 20 of the polarization beam combiner 16 produces the combined TE+TM components for all the other wavelengths. The AOTF 10 has essentially “dropped” the phase-matching wavelength selected by the oscillator frequency fₐ and has passed through all other wavelengths. Therefore, the AOTF 10 performs the function of a tunable bandpass filter. The center frequency of the bandpass filter can be modified by changing the oscillator frequency fₐ, and therefore, the phase-matching wavelength.

Thus, the AOTF 10 can be configured as an add/drop multiplexer that drops one particular wavelength, and passes all other wavelengths. The signal propagating through the AOTF 10 has an empty spectral “slot” that corresponds to the spectral slot of the dropped signal. A new locally generated signal is then applied to a second input port 34 of the polarization beamsplitter 12. The AOTF 10 inserts this signal into the empty slot at #₂ in the “through” output. This is done simultaneously with the “dropping” of the input channel centered at #₂. Thus, the AOTF can be configured to simultaneously add and drop an optical signal.

The AOTF 10 can also be configured to add/drop multiple optical wavelengths. This is accomplished by using an oscillator signal that is a superposition of several sinusoids at different frequencies. The ability to add/drop multiple wavelengths is a unique characteristic of the AOTF and has application in WDM optical transport systems.

The AOTF 10 has several practical limitations that make it difficult to implement in commercial optical transport systems. One such limitation is that it is relatively difficult and expensive to control the temperature of the AOTF to within a desired temperature range. If the desired temperature range is not achieved, the temperature offset from nominal can cause a shift in the wavelength to which the filter is phase matched. In addition, a temperature gradient along the device can result in asymmetric sidelobes and incomplete mode conversion, which can cause an unacceptable level of crosstalk as well as broaden the filter bandwidth.

One or more heaters or thermoelectric coolers can be used to control the temperature of the devices. However, heaters and thermoelectric coolers are typically power-intensive and expensive devices that are physically large in size. Furthermore, temperature control systems may be required to sense the temperature at several points along the length of the device, and separate control circuits may be required for each sensor. Such a temperature control system can significantly add to the cost of deploying an AOTF.

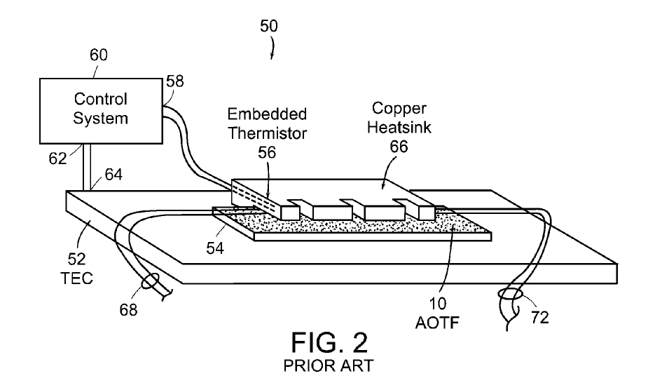

FIG. 2 illustrates a known temperature controlled AOTF 50 that includes an integrated AOTF 10 and a thermoelectric cooler (TEC) 52 for maintaining the substrate 54 of the integrated AOTF 10 at a relatively constant temperature. The temperature controlled AOTF 50 of FIG. 2 also includes a thermistor 56 that is coupled to an input 58 of a control system 60. The control system 60 includes an output 62 that is coupled to an input 64 of the TEC 52. A heatsink 66 may be positioned in contact with the AOTF 10. The heatsink 66 is adapted to assist in maintaining the desired temperature of the AOTF 10. At least one fiber in a pair of input fibers 68 is connected to the AOTF inputs 18 and 34 (FIG. 1). At least one fiber in a pair of output fibers 72 is coupled to the AOTF outputs 20 and 22 (FIG. 1).

In operation, an optical signal having multiple wavelengths is transmitted by the optical signal source through at least one fiber in the pair of input fibers 68 to the AOTF input 18 (FIG. 1). The optical signal then propagates through the AOTF 10. As previously discussed with reference to FIG. 1, an acoustic beam generated by a SAW launcher (not shown) is launched into the optical waveguide material of the AOTF 10 and travels through the optical waveguide material as acoustic waves. As a peak of an acoustic wave passes through the optical waveguide material, it causes small local perturbations in the refractive index of the optical waveguide material. One band of optical wavelengths is strongly affected by the local perturbations caused by the acoustic waves. The affected band can be distinguished from the remaining wavelengths as previously discussed with reference to FIG. 1.

Referring back to Equation (1), the birefringence #n of the optical waveguide material and the speed of sound Vₛ in the substrate material are properties of the specific material from which the AOTF 10 is fabricated. These material properties vary with temperature. Therefore, if the acoustic drive frequency f a is held constant, then the corresponding phase-matched optical wavelength #₀ also changes with temperature. Thus, as the temperature of the AOTF 10 changes, the desired passband of the AOTF also changes.

To prevent this from occurring, the control system 60 sends an electrical signal to the TEC 52. In response to the electrical signal, the TEC 52 adjusts its temperature. Since the AOTF 10 is in contact with the TEC 52, and the mass of the TEC 52 is much greater than that of the AOTF 10, the AOTF 10 tends to reach and remain at the same temperature as the TEC 52. The heatsink 66 assures that the regulated temperature of the AOTF 10 is uniform throughout the entire AOTF 10. In the event that the temperature in the AOTF 10 changes or becomes unstable, the control system 60 reacts by regulating the temperature of the TEC 52 in response to signals received from the embedded thermistor 56. Once the temperature of the AOTF is regulated, the optical signal having the desired passband passes through at least one of the pair of output fibers 72.

Temperature changes in the AOTF material can be caused by inefficiencies in the SAW launcher, conversion of acoustic energy into heat by loses in the material and absorption by an acoustic load, as well as the effect of ambient temperature. As previously discussed, trying to regulate the temperature of the AOTF material can be difficult, complex, and expensive.

In one aspect, the present invention maintains phase-matching of an acoustic wave to a constant optical wavelength #₀ over a range of temperatures by adjusting the acoustic drive frequency fₐ to substantially compensate for changes in the speed of sound Vₛ and changes in the birefringence #n of at least one optical waveguide in an acousto-optic device. Each of these quantities varies as a function of the temperature of the material. The phase-matching formula includes the product of two temperature-dependent quantities Vₛ sand #n, as shown in Equation (1). Therefore, the product Vₛ#n can be represented as a single temperature dependent function, K(T) as shown in Equation (2) as follows:

K(T)=V,(T)·Δn(T)

Combining Equation (1) and Equation (2) results in Equation (3) as follows for the acoustic drive frequency, fₐ (T):

$${f}_{a} ( T ) = \frac{K ( T )}{{λ}_{0}}$$

The function K(T) is generally known, either from published data or by direct or indirect measurement on actual AOTF devices. Equation (3) indicates the value of the acoustic drive frequency fₐ (T) that is required to phase-match the acoustic wave to the optical wavelength #₀ at any temperature T. In other words, if #₀ is kept constant, Equation (3) specifies how fₐ (T) should be varied as a function of temperature T in order to maintain the constant optical wavelength #₀.

Additionally, since the birefringence #n is also a function of optical wavelength #₀, there is a different function K(T) for each distinct value of the optical wavelength #₀. However, for most practical applications of AOTF devices, such as filters for DWDM communication systems, the wavelength band of interest is suitably small. Thus, the variations in the birefringence #n as a function of optical wavelength #₀ are also relatively small. Therefore, in one embodiment, a single function K(T) can be used for a small optical wavelength band.

Skilled artisans will appreciate that although the invention is described in the context of an acousto-optic tunable filter based on polarization mode conversion, the invention is applicable to all acousto-optic devices that depend on maintaining specific phase-matching criteria during temperature variations.

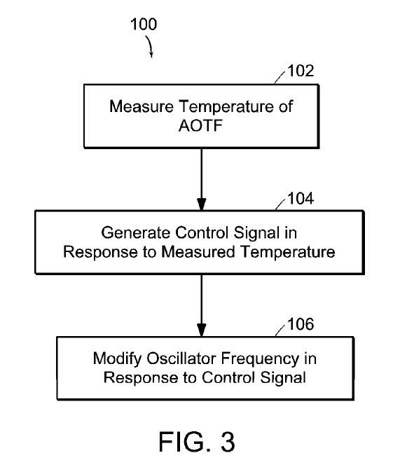

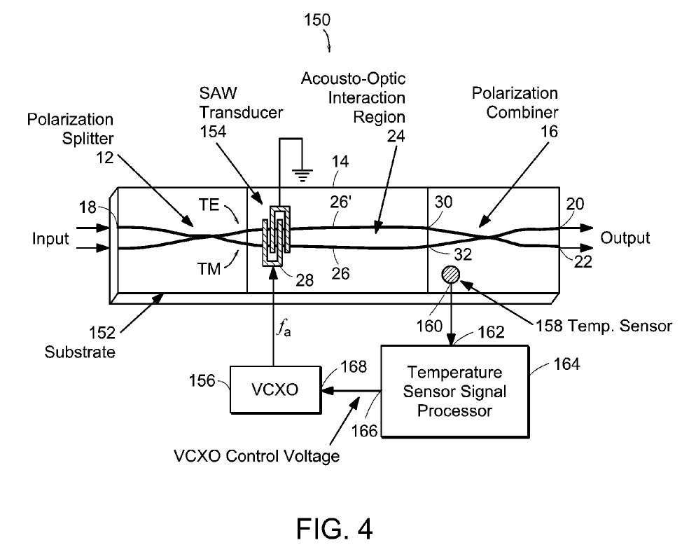

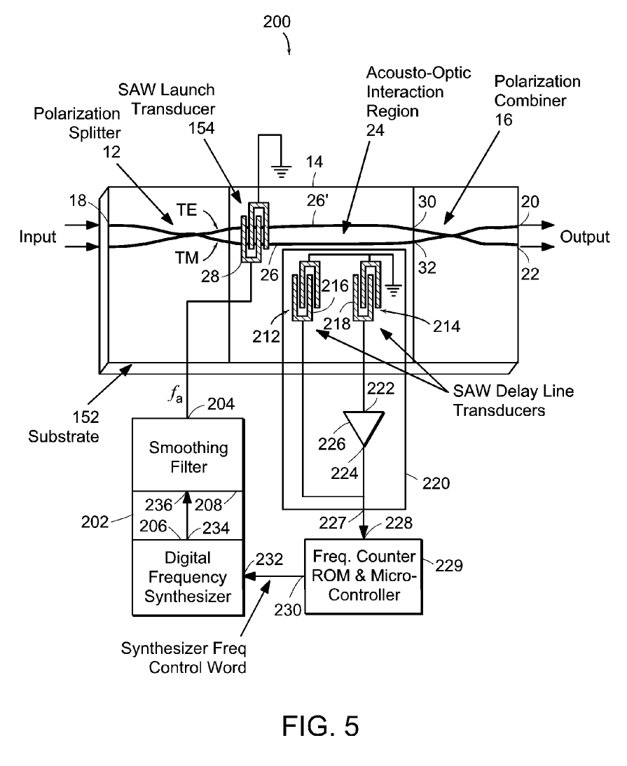

FIG. 3 is a flow diagram 100 of an embodiment of a method of maintaining phase-matching criteria of an acousto-optic tunable filter (AOTF) during temperature variations according to the present invention. The flow diagram 100 includes three steps. The flow diagram 100 includes the step 102 of measuring the temperature of the AOTF. In one embodiment, the step 102 of measuring the temperature is performed directly by measuring the temperature of the substrate of the AOTF with a temperature sensor, such as a thermocouple, thermistor, or a semiconductor junction. Direct measurement of temperature is described herein in more detail in connection with FIG. 4. In another embodiment, the measurement of the temperature is performed indirectly as described herein in more detail in connection with FIG. 5. An average temperature of the AOTF can be determined by measuring the temperature of the AOTF at a plurality of locations.

The flow diagram 100 also includes the step 104 of generating a control signal in response to the step 102 of measuring the temperature. The control signal is used to change a frequency of a signal applied to a surface acoustic wave (SAW) transducer or SAW launcher positioned in the AOTF. In one embodiment, the control signal is a function of the measured temperature T of the AOTF and the selected optical wavelength #₀.

The flow diagram 100 also includes the step 106 of changing the frequency of the signal applied to the SAW transducer in response to the control signal. The frequency is changed such that Equation (3) is satisfied for the measured value of the temperature T and the specified value of optical wavelength #₀. When Equation (3) is satisfied, the frequency is adjusted such that the effects of temperature variations in the substrate are mitigated and the phase-matching criteria of the AOTF are maintained. Thus, the control signal is a function of the measured temperature of the AOTF and a wavelength that corresponds to the phase-matching criteria of the AOTF. In one embodiment, the frequency adjustment is made using a temperature sensor signal processor that is coupled to an oscillator driver that drives the SAW transducer.

The signal applied to the SAW transducer maintains the phase-matching criteria as the birefringence #n in one or both of the optical waveguides changes as a result of temperature changes in the substrate of the AOTF. The signal applied to the SAW transducer can also maintain the phase-matching criteria as the speed of sound Vₛ in one or both of the optical waveguides changes as a result of temperature changes in the substrate of the AOTF.

FIG. 4 illustrates a temperature compensated acousto-optic tunable filter device 150 according to one embodiment of the present invention. The AOTF 150 is similar to the AOTF 10 of FIG. 1 and includes an input polarization beamsplitter 12, a polarization mode-converter 14, and a polarization beam combiner 16. The AOTF 150 also includes an acousto-optic interaction region 24 that comprises a pair of parallel optical waveguides 26, 26′ that are formed in the surface of an acousto-optic substrate 152.

The polarization mode-converter 14 includes a surface acoustic wave (SAW) transducer 154, which in one configuration, is a set of inter-digitated conducting fingers 28 that are formed over or proximate to the pair of optical waveguides 26, 26′ that are formed in the acousto-optic substrate 152. The optical waveguides 26, 26′ carry the separated TE and TM modes that are formed by the polarization beamsplitter 12.

An oscillator 156 that generates an acoustic waveform having a frequency fₐ is electrically connected to the conducting fingers 28. In one configuration, the oscillator 156 is a sinusoidal oscillator. In one embodiment, the oscillator 156 is a voltage controlled crystal oscillator (VCXO). The oscillator 156 drives the conducting fingers 28 that generate a surface acoustic wave (SAW) that propagates approximately collinearly along the pair of optical waveguides 26, 26′. In one configuration, the SAW itself is guided through the use of an acoustic waveguide structure.

In one embodiment, the temperature compensated acousto-optic tunable filter device 150 also includes a temperature sensor 158. Any type of temperature sensor can be used. For example, the temperature sensor 158 can be a thermocouple, thermistor, or a solid-state temperature sensor, such as a semiconductor junction. In one embodiment, the temperature sensor 158 is a temperature sensing integrated circuit (IC).

In the embodiment in which the temperature sensor 158 is a thermistor, the resistance of the device is changed as the temperature of the device changes. Typically thermistors change their resistance exponentially with temperature. Thus, in one embodiment, the temperature sensor signal processor 164 tracks the resistance of the thermistor in order to generate control signals that are related to the temperature of the acousto-optic substrate 152.

The temperature sensor 158 can be embedded in the acousto-optic substrate 152. Alternatively, the temperature sensor 158 can be positioned proximate to, or in contact with the acousto-optic substrate 152. In one embodiment, multiple temperature sensors (not shown) are positioned across an area of the acousto-optic substrate 152 in order to measure an average temperature of area of the acousto-optic substrate 152 or a portion of the area of the acousto-optic substrate 152.

An output 160 of the temperature sensor 158 is coupled to an input 162 of a temperature sensor signal processor 164. In one embodiment, the temperature sensor signal processor 164 is a digital signal processor and the temperature sensor signal processor 164 generates a digital word that is representative of the temperature. This temperature, along with the selected optical wavelength #₀, is then sent to a processor within the temperature sensor signal processor 164. The processor implements Equation (3) and uses other system parameters to determine the control signal.

An output 166 of the temperature sensor signal processor 164 is coupled to an input 168 of the oscillator 156. The input 168 of the oscillator 156 receives the control signal. Skilled artisans will appreciate that other processing can be used to generate a control signal that is compatible with the oscillator 156.

For example, in the embodiment in which the oscillator 156 is a voltage-controlled crystal oscillator (VCXO), the processor generates a digital word that is converted from a digital control signal to an analog control signal before the signal is transmitted to the oscillator 156. The digital-to-analog converted control signal is then fed to a voltage control input of the VCXO. The control voltage determines the frequency of the VCXO, which is the value fₐ(T) given by Equation (3), that is used to establish the phase-matching criteria that is described herein.

In another embodiment, the oscillator 156 can be a digital frequency synthesizer. In this embodiment, the appropriate control signal is a digital word that is sent directly from a processor to the digital frequency synthesizer. The output of the digital frequency synthesizer is smoothed with an analog filter before it drives the SAW transducer 154.

Skilled artisans will appreciate that as the temperature of the substrate 152 changes, the control signal can be dynamically changed in response to the changes in the temperature of the substrate. By dynamically adjusting the control voltage of the VCXO, for example, the phase-matching criteria can be satisfied for a range of substrate temperature values. If the optical wavelength #₀ of the optical beam is not phase-matched to the acoustic frequency fₐ(T), then substantially no mode conversion occurs, and the light beam simply propagates down the optical waveguides 26, 26′.

The oscillator 156 drives the SAW transducer 154. The SAW transducer 154 causes an anisotropic perturbation of the indices of refraction in the pair of optical waveguides 26, 26′. This perturbation causes a mode conversion that occurs gradually as the optical signals propagate through the pair of optical waveguides 26, 26′. Eventually, complete mode conversion of the phase-matching optical signals occurs. This is when substantially the entire TE mode is converted to the TM mode in one waveguide 26′ and substantially the entire TM mode is converted to the TE mode in the other waveguide 26 of the pair of optical waveguides 26, 26′.

The polarization beam combiner 16 is physically identical to the polarization beamsplitter 12. However, the polarization beam combiner 16 is configured to combine rather than split the light beams. The polarization beam combiner 16 has a first 30 and a second input port 32 that receives the TM mode and the TE mode.

The temperature compensated acousto-optic tunable filter device 150 of the present invention can be an integrated AOTF that combines the polarization beamsplitter 12, polarization mode-converter 14, and the polarization beam combiner 16 on a planar substrate that is birefringent, photoelastic, and piezoelectric, such as lithium niobate. In another embodiment, the temperature compensated acousto-optic tunable filter device 150 can be a discrete AOTF (not shown) that uses separate polarization beamsplitters, polarization beam combiners, and acousto-optic interaction regions. For example, the polarization beamsplitter and polarization beam combiner can be discrete planar devices, such as beam-splitting prisms, walk-off prisms and collimating lenses. In that embodiment, one or more temperature sensors can be used on the discrete planar devices and/or the acousto-optic interaction regions. The principles of operation of temperature compensated integrated and discrete AOTFs are similar.

In operation, a single-mode optical beam comprising, for example, three channels centered at optical wavelengths #₁, #₂, and #₃ enters the polarization beamsplitter 12 through the first input 18. The polarization beamsplitter 12 separates the optical beam into TE and TM modes. The TE and TM modes propagate down separate waveguides 26, 26′ in the polarization mode-converter 14. Portions of the TE and TM modes are mode-converted by the polarization mode-converter 14. The TE and TM modes are then combined in the polarization beam combiner 16.

The mode-converter oscillator frequency is chosen to phase-match to one of the three optical channels. For example, the oscillator frequency can be chosen to phase-match to #₂. The temperature sensor signal processor 164 monitors the temperature of the substrate 152 and then adjusts the control signal in response to changes detected by the temperature sensor 158. The temperature sensor signal processor 164 and the oscillator 156 adjust the oscillator frequency such that the phase-matching criteria is satisfied at all times and for all operating temperatures.

In this example, the portions of the TE and TM modes centered at #₂ are mode-converted to TM and TE, respectively, while portions centered at other wavelengths propagate down the waveguides 26, 26′ without any polarization mode conversion. The TE mode couples straight through the polarization beam combiner 16 and the TM mode crosses over in the polarization beam combiner 16. Polarization splitters and combiners can also be designed to couple the TM mode straight through and to cross-couple the TE mode. In this configuration, the overall operation of the filter is the same.

The second output port 22 of the polarization beam combiner 16 produces the combined TE+TM components centered at the phase-matching wavelength #₂ whereas the first output port 20 of the polarization beam combiner 16 produces the combined TE+TM components for all the other wavelengths. The temperature compensated AOTF 150 has essentially “dropped” the phase-matching wavelength selected by the oscillator frequency fₐ(T) and passed through all other wavelengths. Therefore, the temperature compensated AOTF 150 performs the function of a tunable bandpass filter. The center frequency of the bandpass filter can be modified by changing the oscillator frequency fₐ(T), and therefore, the phase-matching wavelength.

FIG. 5 illustrates a temperature compensated acousto-optic tunable filter device 200 according to another embodiment of the present invention. This embodiment uses an indirect temperature measurement to compensate for temperature variations. In other respects, the temperature compensated AOTF 200 is similar to the temperature compensated AOTF 150 of FIG. 4 and includes an input polarization beamsplitter 12, a polarization mode-converter 14, and a polarization beam combiner 16. The temperature compensated AOTF 200 also includes an acousto-optic interaction region 24 that contains a pair of parallel optical waveguides 26, 26′ that are formed in the surface of a substrate 152.

The polarization mode-converter 14 includes a surface acoustic wave (SAW) transducer 154, which in one configuration, is a set of inter-digitated conducting fingers 28 that are formed over or proximate to the pair of optical waveguides 26, 26′. The optical waveguides 26, 26′ carry the separated TE and TM modes that are formed by the polarization beamsplitter 12.

An oscillator 202 generates an electrical signal having a frequency fₐ at an output 204. The output 204 is electrically coupled to the conducting fingers 28. In one embodiment, the oscillator 202 includes a digital frequency synthesizer 206 and an analog smoothing filter 208. The oscillator 202 drives the conducting fingers 28 which generate a surface acoustic wave (SAW) that propagates approximately collinearly along the pair of optical waveguides 26, 26′. In one configuration, the SAW itself is guided through the use of an acoustic waveguide structure.

The temperature compensated acousto-optic tunable filter device 200 utilizes indirect temperature measurement to generate a control signal that controls the oscillator 202. The indirect temperature measurement is accomplished through the use of a first 212 and a second SAW transducer 214 that are positioned in the acousto-optic interaction region 24. In one embodiment, the first 212 and the second SAW transducers 214 are in the close physical proximity to the region where optical mode conversion occurs.

The first SAW transducer 212 includes a first set of inter-digitated conducting fingers 216. The first SAW transducer 212 generates a SAW that propagates in close proximity to the acousto-optic interaction region 24, but that does not overlap with the mode-converting SAW that is generated by the SAW transducer 154 or the optical waveguides 26, 26′.

The second SAW transducer 214 includes a second set of inter-digitated conducting fingers 218 that function as a pickup transducer. The SAW generated by the first SAW transducer 212 propagates to the second set of inter-digitated conducting fingers 218. The second SAW transducer 214 generates an output voltage that is proportional to the strength of the SAW that propagates through the second set of inter-digitated conducting fingers 218 because of an inverse piezoelectric effect.

Thus, the first 212 and the second SAW transducers 214 together behave like an electrical delay line having a delay time that is equal to the time required for the SAW generated by the first SAW transducer 212 to propagate from the first SAW transducer 212 (launch transducer) to the second SAW transducer 214 (pickup transducer). The delay time is equal to D/Vₛ where D is the distance between the first 212 and the second SAW transducers 214 and Vₛ is the speed of sound in the substrate material. Since both D and Vₛ are functions of temperature, the delay time itself is a function of temperature.

In one embodiment, a SAW oscillator 220 is created by connecting a delay line between an input 222 and an output 224 of an amplifier 226. In this embodiment, the delay line is generated using the first 212 and the second SAW transducers 214. For example, the amplifier 226 can be a radio-frequency (RF) amplifier.

This embodiment of the invention involves measuring the frequency f_{T}, of the SAW oscillator 220, rather than making a direct measurement of the temperature of the substrate 152. Since the frequency f_{T} of the SAW oscillator 220 depends on the value of the delay time, and the delay time is a function of temperature, the frequency f_{T} of the SAW oscillator 220 is also function of temperature.

It may be useful to calibrate the SAW oscillator 220 to properly utilize this indirect temperature measurement. In one embodiment, the SAW oscillator 220 is calibrated in two parts. First, the frequency f_{T} of the SAW oscillator 220 is calibrated against temperature. This calibration requires that the frequency f_{T} of the SAW oscillator 220 be measured for each given temperature T.

Second, for the same temperature calibrated in the first step, the exact frequency fₐ of the oscillator 202 that results in a phase-match to a specified optical wavelength #₀, is measured. The measurement is done for each value of the optical wavelength #₀ where phase-matching is to occur. In other words, this measurement is done for each optical channel that the temperature compensated AOTF 200 must drop if it is used as a filter in a WDM system.

For each selected value of the optical wavelength #₀ and for each temperature T, there is a one-to-one correspondence between the frequency f_{T} of the SAW oscillator 220 and the frequency fₐ of the oscillator 202. This correspondence is used to control the frequency fₐ of the oscillator 202 as a function of temperature.

An output 227 of the oscillator 220 is coupled to an input 228 of a frequency counter 229. In one embodiment, the frequency f_{T} of the SAW oscillator 220 is measured with the frequency counter 229. The frequency counter 229 generates a digital word that represents the SAW oscillator frequency f_{T}. The digital word is used as the input address to a Read Only Memory (ROM) (not shown) within the frequency counter 229.

The ROM stores the one-to-one correspondence between f_{T} and fₐ. The output of the ROM is a digital word corresponding to the correct frequency fₐ of the digital frequency synthesizer 202. This value, along with the value of the selected optical wavelength #₀, is then sent to a processor within the frequency counter 229. The processor generates a digital word that corresponds to a digital control signal. An output 230 of the frequency counter 229 is coupled to an input 232 of the oscillator 202. The digital control signal is used as the frequency control signal to the oscillator 202.

In the embodiment shown, the oscillator 202 is implemented as the digital frequency synthesizer 206 and the digital control signal directly controls the frequency of the synthesizer 202. An output 234 of the digital frequency synthesizer 206 is coupled to an input 236 of the analog smoothing filter 208. In another embodiment, the oscillator is a VXCO and the digital control signal is converted to an analog frequency control voltage for the VXCO.

The indirect temperature measurement technique described with reference to FIG. 5 is advantageous because the indirect temperature sensor (i.e. the SAW delay line) is fabricated directly on the substrate 152 in close proximity to the optical waveguides 26, 26′. Thus, the indirect temperature measurement can provide very accurate results. The indirect temperature measurement technique can be a lower cost solution, since the first 212 and the second SAW transducers 214 can be fabricated simultaneously with the main phase-matching SAW transducer 154.

Skilled artisans will appreciate that as the temperature of the substrate 152 changes, the digital control signal that controls the digital frequency synthesizer 206 can be dynamically changed in response to the changes in the temperature of the substrate 152.

The oscillator 202 drives the SAW transducer 154. The SAW transducer 154 causes an anisotropic perturbation of the indices of refraction in the pair of optical waveguides 26, 26′. This perturbation causes a mode conversion that occurs gradually as the optical signals propagate through the pair of optical waveguides 26, 26′. Eventually, complete mode conversion of the phase-matching optical signals occurs. By complete mode conversion, we mean when substantially the entire TE mode is converted to the TM mode in one waveguide 26′ and substantially the entire TM mode is converted to the TE mode in the other waveguide 26 of the pair of optical waveguides 26, 26′.

The polarization beam combiner 16 is physically identical to the polarization beamsplitter 12. However, the polarization beam combiner 16 is configured to combine rather than split the light beams. The polarization beam combiner 16 has a first 30 and a second input port 32 that receives the TM mode and the TE mode.

The temperature compensated acousto-optic tunable filter device 200 of the present invention can be an integrated AOTF that combines the polarization beamsplitter 12, polarization mode-converter 14, and the polarization beam combiner 16 on a planar substrate that is birefringent, photoelastic, and piezoelectric, such as lithium niobate. In another embodiment, the temperature compensated acousto-optic tunable filter device 200 can be a discrete AOTF (not shown) that uses separate polarization beamsplitters, polarization beam combiners, and acousto-optic interaction regions. For example, the polarization beamsplitter and polarization beam combiner can be discrete planar devices, such as beam-splitting prisms, walk-off prisms and collimating lenses. The principles of operation of temperature compensated integrated and discrete AOTFs are similar.

In operation, a single-mode optical beam comprising, for example, three channels centered at optical wavelengths #₁, #₂, and #₃ enters the polarization beamsplitter 12 through the first input 18. The polarization beamsplitter 12 separates the optical beam into TE and TM modes. The TE and TM modes propagate down separate waveguides 26, 26′ in the polarization mode-converter 14. Portions of the TE and TM modes are mode-converted by the polarization mode-converter 14. The TE and TM modes are then combined in the polarization beam combiner 16.

The mode-converter oscillator frequency is chosen to phase-match to one of the three optical channels. For example, the oscillator frequency can be chosen to phase-match to #₂. Since the oscillator frequency is a function of temperature, the frequency counter 229 monitors the frequency of the SAW oscillator 220 and then sends the correct digital control signal to the digital frequency synthesizer 206 in response to the indirectly-measured temperature changes monitored by the frequency counter 229. The frequency counter 229 essentially adjusts the digital frequency synthesizer 206 such that the phase-matching criteria is satisfied dynamically over a wide range of temperatures.

In this configuration, the portions of the TE and TM modes centered at #₂ are mode-converted to TM and TE, respectively, while portions centered at other wavelengths propagate down the waveguides without any polarization mode conversion. The TE mode couples straight through the polarization beam combiner 16 and the TM mode crosses over in the polarization beam combiner 16. Polarization splitters and combiners can also be designed to couple the TM mode straight through and to cross-couple the TE mode. In this configuration, the overall operation of the filter is the same.

The second output port 22 of the polarization beam combiner 16 produces the combined TE+TM components centered at the phase-matching wavelength #₂ whereas the first output port 20 of the polarization beam combiner 16 produces the combined TE+TM components for all the other wavelengths. The temperature compensated AOTF 200 has “dropped” the phase-matching wavelength selected by the oscillator frequency fₐ(T) and passed through all other wavelengths. Therefore, the temperature compensated AOTF 200 performs the function of a tunable bandpass filter. The center frequency of the bandpass filter can be modified by changing the oscillator frequency fₐ(T), and therefore, the phase-matching wavelength.

Although the invention described herein for temperature-compensating an acousto-optic device is described in the context of an optical filter using polarization mode conversion, those skilled in the art will appreciate that the methods and apparatus of temperature compensation that are described herein are also applicable to other types of acousto-optic devices. Specifically, acousto-optic devices used as modulators or optical beam deflectors do not necessarily use polarization mode conversion. Such devices can use bulk acoustic waves rather than surface acoustic waves. These devices can use the same direct or indirect temperature compensation methods and apparatus that are described herein to maintain their optical modulation and beam deflection characteristics over their operating ranges. In devices that use bulk acoustic waves, an indirect temperature sensor according to the present invention can be formed of a bulk acoustic wave delay line rather than a surface acoustic wave delay line.

Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A method of maintaining phase-matching criteria of an acousto-optic device during temperature variations, the method comprising:
a) measuring a temperature of the acousto-optic device;
b) generating a control signal in response to the measured temperature; and
c) changing a frequency of a signal applied to an acoustic wave transducer positioned in the acousto-optic device in response to the control signal, the frequency of the signal being chosen to maintain the phase-matching criteria of the acousto-optic device.

2. The method of claim 1 wherein the measuring the temperature of the acousto-optic device comprises directly measuring a temperature of the acousto-optic device.

3. The method of claim 1 wherein the measuring the temperature of the acousto-optic device comprises directly measuring a temperature of an acousto-optic substrate in the acousto-optic device.

4. The method of claim 1 wherein the measuring the temperature of the acousto-optic device comprises indirectly measuring a temperature of the acousto-optic device.

5. The method of claim 4 wherein the indirectly measuring the temperature of the acousto-optic filer comprises measuring a delay time of an acoustic wave propagating between a first transducer and a second transducer in the acousto-optic device.

6. The method of claim 1 wherein the measuring the temperature of the acousto-optic device comprises measuring a temperature at a plurality of locations in the acousto-optic device to determine an average temperature.

7. The method of claim 1 wherein the control signal is a function of the measured temperature of the acousto-optic device and a wavelength that corresponds to the phase-matching criteria of the acousto-optic device.

8. The method of claim 1 wherein the signal applied to the acoustic wave transducer maintains the phase-matching criteria when a birefringence in at least one optical waveguide in the acousto-optic tunable device changes.

9. The method of claim 1 wherein the signal applied to the acoustic wave transducer maintains the phase-matching criteria when a speed of sound in at least one optical waveguide in the acousto-optic tunable device changes.

10. An acousto-optic tunable device comprising:
a) an acousto-optic substrate;
b) an acoustic wave transducer positioned on the acousto-optic substrate;
c) a temperature sensor that is positioned in thermal communication with the acousto-optic substrate, the temperature sensor generating an electrical signal at an output that is related to a temperature of the acousto-optic substrate;
d) a processor having an input that is electrically coupled to the output of the temperature sensor, the processor generating a control signal at an output in response to the electrical signal generated by the temperature sensor; and
e) an oscillator having a control input that is electrically coupled to the output of the processor and having an output that is electrically coupled to the acoustic wave transducer, a frequency of the oscillator being changed in response to the control signal in order to maintain phase-matching criteria of the acousto-optic tunable device as the temperature of the acousto-optic substrate changes.

11. The acousto-optic tunable device of claim 10 wherein the acousto-optic tunable device comprises an acousto-optic tunable filter.

12. The acousto-optic tunable device of claim 10 wherein the temperature sensor is positioned proximate to the acousto-optic substrate.

13. The acousto-optic tunable device of claim 10 wherein the temperature sensor is embedded in the acousto-optic substrate.

14. The acousto-optic tunable device of claim 10 wherein the temperature sensor is chosen from the group comprising a thermocouple, a thermistor, and a semiconductor junction.

15. The acousto-optic tunable device of claim 10 wherein the temperature sensor measures an average temperature of a portion of the acousto-optic substrate.

16. The acousto-optic tunable device of claim 10 wherein the oscillator comprises a voltage controlled crystal oscillator (VXCO).

17. The acousto-optic tunable device of claim 10 wherein the oscillator comprises a digital frequency synthesizer.

18. The acousto-optic tunable device of claim 10 wherein the control signal is a function of the temperature of the acousto-optic substrate and a desired phase matching wavelength of the acousto-optic tunable device.

19. The acousto-optic tunable device of claim 10 wherein the frequency of the oscillator is changed in order to maintain the phase-matching criteria when a birefringence in at least one optical waveguide in the acousto-optic tunable device changes.

20. The acousto-optic tunable device of claim 10 wherein the frequency of the oscillator is changed in order to maintain the phase-matching criteria when a speed of sound in at least one optical waveguide in the acousto-optic tunable device changes.

21. A device for maintaining phase-matching criteria in an acousto-optic device during temperature variations, the device comprising:
a) means for measuring a temperature of the acousto-optic device;
b) means for generating a control signal in response to the measured temperature; and
c) means for changing the frequency of a signal applied to an acoustic wave transducer positioned in the acousto-optic device in response to the control signal, the frequency of the signal being chosen to maintain the phase-matching criteria of the acousto-optic device.
